(19) United States
(12) Patent Application Publication
(10) Pub. No.: US 2008/0074566 A1
(43) Pub. Date: Mar. 27, 2008

(54) Auto darkening eye protection device

(76) Inventor: Yea-Chyi Yang, Yingge Township (TW)

Correspondence Address: BIRCH STEWART KOLASCH & BIRCH, PO BOX 747, FALLS CHURCH, VA, 22040-0747, US

(21) Appl. No.: 11/527,686

(22) Filed: Sep. 27, 2006

(51) Int. Cl. G02F 1/1335

(52) U.S. Cl. 349/14

(57) ABSTRACT

An auto darkening eye protection device, including a first filter, a second filter, at least one liquid crystal filter and a control circuit, is provided. The first filter and the second filter are made of light-transmitting plastic and with films to shade ultraviolet (UV) and infrared (IR) rays. The liquid crystal filter is hermetically set between the first filter and the second filter to obtain better light-transmitting. Besides, the first filter and the second filter are manufactured by plastic injection molding so there are some advantages that are easy manufacturing, low cost, impact endurance, light and filmy.

### BACKGROUND

1. Field of Invention

The present invention relates to a protection device, and more particularly to a welding auto darkening eye protection device.

2. Description of Related Art

Refer to FIG. 1 and FIG. 2. FIG. 1 is a front view which illustrates an auto darkening filter (ADF) for welding in accordance with the prior art, and FIG. 2 is a sectional view which illustrates the auto darkening filter (ADF) for welding in accordance with the prior art. A conventional filter device 100 includes two (or single) liquid crystal filter 101 with light-transmitting, a coated glass filter 102 with light-transmitting, a protective glass 103 with light-transmitting, a first housing 104, a second housing 105, a control circuit 108, a solar cell 109 and one or more than one sensors 110. The first housing 104 and the second housing 105 are made of plastic with opacity. The control circuit 108 is located between the first housing 104 and the second housing 105. The solar cell 109 is exposed and electrically connected with the control circuit 108. The sensors 110 are exposed and electrically connected with the control circuit 108.

When an incident light (L) enters into the filter device 100, the ultraviolet (UV) and the infrared (IR) rays are shaded by the glass filter 102 and the visible light is filtered by the liquid crystal filters 101 to generate a transmitted light (L′). Thus, the ultraviolet (UV), the infrared (IR) ray and the visible light are filtered to comply with the safety standards of various countries. However, there are still some shortages in the structure design of the conventional filter device 100:

1. The glass filter 102 functions not only a substrate for filtering light but also a protection for polarizer on the liquid crystal filter 101 as the same as the protective glass 103. If the glass filter 102 is flimsy, the strength is reduced such that the glass filter 102 is too fragile. Contrarily, if the glass filter 102 is thick, the weight and thickness of the auto darkening eye protection device 100 are increased to raise the manufacturing cost.

2. Because the conventional filter 102 is made of glass and the ultraviolet and the infrared ray are shaded. Besides, there is another filter manufacturing technology that coats a film on the plastic material. However, the plastic body has lower heat resistance such that the bending and the deformation probably occur. Yet, another economic method is to use a dye on the plastic filter to filter the light, such as the U.S. Pat. No. 6,021,520. But the IR transparency of the liquid crystal filter 101 is very high. Thus, only the filter 102 shades the IR such that the dye ratio of the filter 102 must be increased. In this method, the visible light transmitting is reduced such that the luminance inside the filter device 100 becomes dark before the liquid crystal filter 101 changes into a dark state. Contrarily, decreasing the dye ratio will increase the IR transparency so the safety standards cannot be complied with. Therefore, the filter 102 using plastic material and the dye method cannot comply with the safety standard and get optimal visible light transmitting simultaneously unless increasing the thickness of the filter in the U.S. Pat. No. 6,021,520.

3. In order to fabricate the filter 102 and the protective glass 103, the penetrating window 106 and the penetrating window 107 are respectively defined in the first housing 104 and the second housing 105. By this method, the manufacturing and the cost are raised, and the worse sealing between the filter 102 and the penetrating windows 106 and 107 will affect the polarization of the polarizer in the liquid crystal filter 101 because moisture and air can enter. As a result, the utility period is shortened.

### SUMMARY

It is therefore an objective of the present invention to provide an auto darkening eye protection device to solve the weight, cost, thickness, strength and hazardous problems of the conventional filter and protective plate made of glass.

It is another objective of the present invention to provide an auto darkening eye protection device to solve the manufacturing, yield and cost problems caused by the dye method for filtering the light.

It is another objective of the present invention to provide an auto darkening eye protection device to solve the manufacturing, cost and quality problems caused by the conventional penetrating windows setting in the housing.

An auto darkening eye protection device is provided, and includes a first filter, a second filter, at least one liquid crystal filter and a control circuit. The first filter is made of plastic material with light-transmitting to shade an ultraviolet and an infrared ray. The second filter is made of plastic material with light-transmitting to shade the ultraviolet and the infrared ray. The liquid crystal filter is hermetically set between the first filter and the second filter. The control circuit is electrically connected with the liquid crystal filter to control the liquid crystal filter.

Compared with the conventional filter and protective plate made of the glass, the liquid crystal filter is set between the first filter and the second filter to filter the light. Besides, the first filter surface and the second filter surface can be coated or dyed during the injection molding to compose the desirable dye ratio. By this method, the plastic filters are easier to manufacture and the light-transmitting of the filters can be controlled appropriately. Moreover, the manufacturing cost of the plastic filters can be reduced.

The first filter and the second filter are manufactured by the plastic injection molding such that the light weight, inexpensive, strength and flimsy filters are provided.

Therefore, an auto darkening eye protection device further including a first housing and a second housing is provided. The first housing is made of plastic material and covers the first filter. The second housing is made of plastic material and covers the second filter. Furthermore, the second housing corresponds oppositely to the first housing. Consequently, the first housing and the second housing hermetically cover the first filter, the second filter and the liquid crystal filter.

Hermetically covering the first filter, the second filter and the liquid crystal filter by the first housing and the second housing, and then setting the control circuit, the sensors and the solar cells inside the auto darkening eye protection device. Through this method, the air and the moisture can be prevented from entering into the interior. Thus, excellent water tightness for the body of the auto darkening eye protection device is provided to enhance the stability and the quality of the optical components.

Therefore, an auto darkening eye protection device wherein the first housing and the second housing or the first filter and the second filter are manufactured with strength and anti-fog processes is provided to enhance the hardness and anti-fog effect. Consequently, this auto darkening eye protection device can be used in environments with various temperatures.

In accordance with the previous description, the auto darkening eye protection device of the present invention has the advantage of easier manufacturing, high yield, good light-transmitting, flimsy, inexpensive, strength, good water tightness, stable quality, anti-scrape, anti-fog and lower manufacturing cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a front view of an auto darkening eye protection device in accordance with the prior art;

FIG. 2 shows a sectional view of an auto darkening eye protection device along line 2-2 in FIG. 1;

FIG. 3 shows a front view of the first embodiment of an auto darkening eye protection device of the present invention;

FIG. 4 shows a sectional view of the auto darkening eye protection device along line 4-4 in FIG. 3;

FIG. 5 shows a sectional view of a second embodiment of the auto darkening eye protection device of the present invention;

FIG. 6 shows a sectional view of a third embodiment of the auto darkening eye protection device of the present invention;

FIG. 7 shows a sectional view of a fourth embodiment of the auto darkening eye protection device of the present invention;

FIG. 8 shows a sectional view of a fifth embodiment of the auto darkening eye protection device of the present invention;

FIG. 9 shows a sectional view of a sixth embodiment of the auto darkening eye protection device of the present invention;

FIG. 10 shows a sectional view of a seventh embodiment of the auto darkening eye protection device of the present invention;

FIG. 11 shows a sectional view of an eighth embodiment of the auto darkening eye protection device of the present invention;

FIG. 12 shows a sectional view of a ninth embodiment on the basis of the seventh embodiment in FIG. 10;

FIG. 13 shows a sectional view of a tenth embodiment on the basis of the eighth embodiment in FIG. 11;

FIG. 14 shows a sectional view of an eleventh embodiment on the basis of the first embodiment in FIG. 4;

FIG. 15 shows a sectional view of a twelfth embodiment on the basis of the second embodiment in FIG. 5;

FIG. 16 shows a sectional view of a thirteen embodiment on the basis of the third embodiment in FIG. 6;

FIG. 17 shows a sectional view of a fourteenth embodiment on the basis of the fourth embodiment in FIG. 7;

FIG. 18 shows a sectional view of a fifteenth embodiment on the basis of the fourth embodiment in FIG. 17; and

FIG. 19 shows a sectional view of a sixteenth embodiment on the basis of the fourth embodiment in FIG. 17.

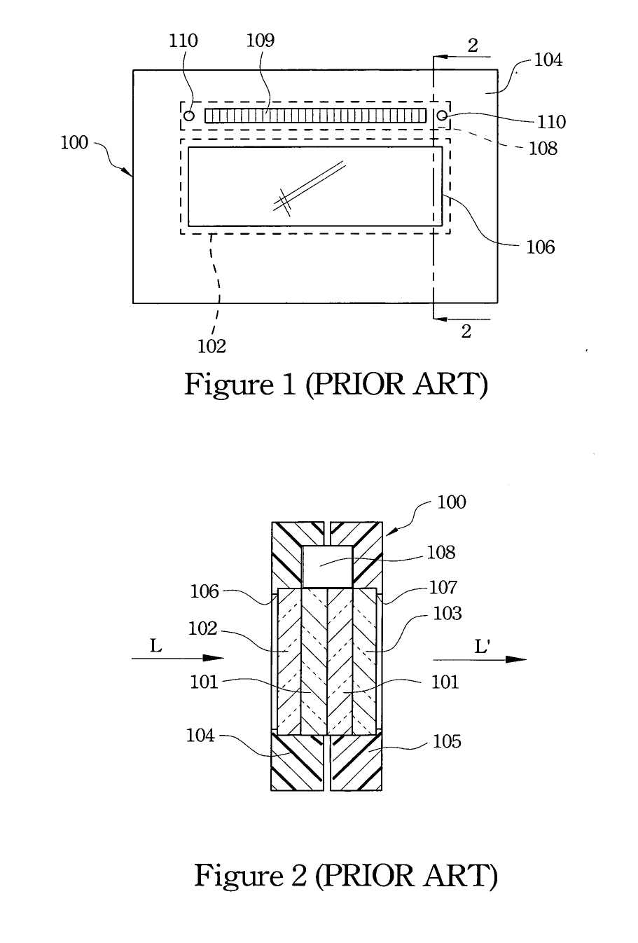

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

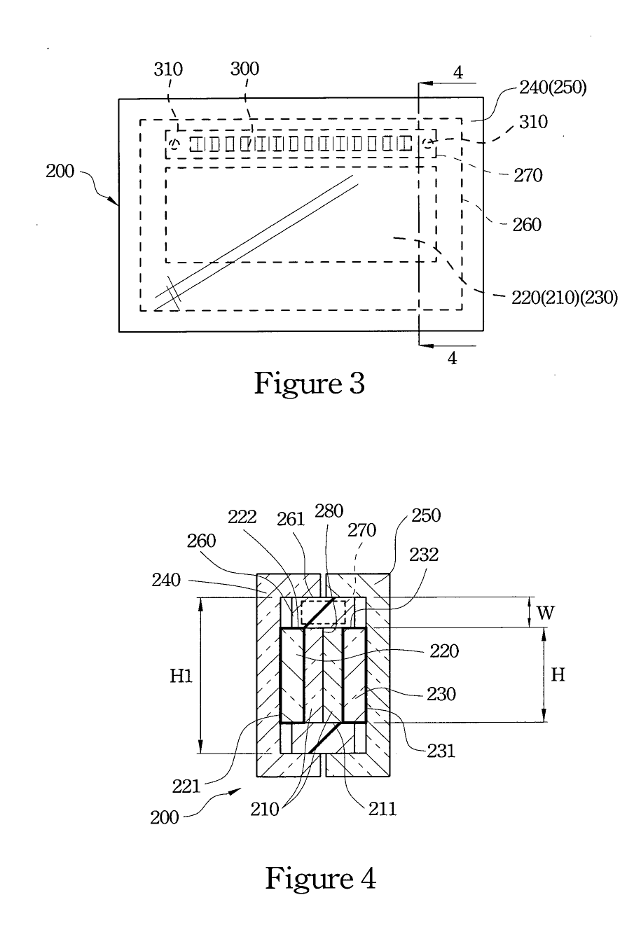

Refer to FIG. 3 and FIG. 4. FIG. 3 illustrates the front view of an auto darkening eye protection device of the first embodiment, and FIG. 4 illustrates the sectional view of an auto darkening eye protection device of the first embodiment. The body 200 includes two liquid crystal filters 210, a first filter 220, a second filter 230, a first housing 240, a second housing 250, a covering layer 260, a control circuit 270, a solar cell 300 and two (one or more than one) sensors 310. The solar cell 300 and the sensors are connected with the control circuit 270 and embedded inside. The first filter 220 and the second filter 230 are both made of plastic material with light-transmitting such that the ultraviolet and the infrared ray can be shaded. A film 221 and a film 231 with the anti-ultraviolet and anti-infrared ray functions are coated on the first filter 220 and the second filter 230. A dye method can also be used to manufacture the filters with anti-ultraviolet and anti-infrared ray functions during the plastic injection molding. The dye method is to add a color capable of absorbing the spectrum of the ultraviolet and the infrared ray.

The liquid crystal filters 210 are hermetically set between the first filter 220 and the second filter 230.

The covering layer 260 is made of the light-opacity material, such as the plastic, the metal and the glass. The covering layer 260 is located in a periphery 211, a periphery 222 and a periphery 232 of the liquid crystal filters 210, the first filter 220 and the second filter 230 to cover the light.

The first housing 240 is made of plastic material with light-transmitting and is hermetically covered in the exterior of the first filter 220. In the first embodiment, the section of the first housing 240 is an inverse U type to further cover a periphery 261 of the covering layer 260.

The second housing 250 is made of plastic material with light-transmitting and is hermetically covered in the exterior of the second filter 230. In the first embodiment, the section of the second housing 250 is an inverse U type to further cover a periphery 261 of the covering layer 260.

The control circuit 270 is electrically connected with the liquid crystal filters 210 to control the liquid crystal filters 210.

In the first embodiment, a height H (the viewing area of the body 200) of the liquid crystal filter 210 is less than a height H1 (the lens window of the body 200) of the covering layer 260. Thus, setting the covering layer 260 is to cover the other areas except the viewing area.

In addition, the control circuit 270 (including dual power designs, a lithium battery and a solar cell) can be pre-embedded in the interior of the covering layer 260 in the molding of the covering layer 260. A supply wire (not shown) is connected between an external power supply and the control circuit 270. When the control circuit 270 area is fitted into the space W between the first housing 240 and the second housing 250 and the first filter 220 and the second 230, the covering layer 260 can be removed. In this way, the control circuit 270 can also cover the light.

As the previous description, the auto darkening eye protection device of the first embodiment of the present invention includes the following effects:

1. In the present invention, the first filter 220 is set in the positive (incident side), and the second filter 230 is set in the negative (exit side). Thus, the ultraviolet and the infrared ray can be shaded and the light can be filtered by the double filters with dyeing method or films 221 and 231. Because the first filter 220 and the second filter 230, made of plastic material, are manufactured by the injection molding, the manufacturing is easy, the yield is higher, the size is flimsy and the manufacturing cost is low.

2. The first filter 220, the second filter 230 and the liquid crystal filters 210 are covered and protected by the first housing 240 and the second housing 250 made of plastic material. Compared with the lens made of the glass material, the present invention has impact endurance, anti-dust effects and waterproof effects. Besides, the lens made of plastic material would not injure people when the lens is broken into pieces after the impact.

3. Furthermore, an adherent layer 280 can be attached between the first housing 240, the first filter 220, the liquid crystal filters 210, the second filter 230 and the second housing 250. Therefore, the quality of the optical components can be kept stable and the using period can also be extended.

4. Additionally, the first housing 240 and the second housing 250 enhance the surface hardness of the body 200 by the strength process. Moreover, the auto darkening eye protection device of the present invention can be normally used in the low temperature circumstances after the anti-fog process.

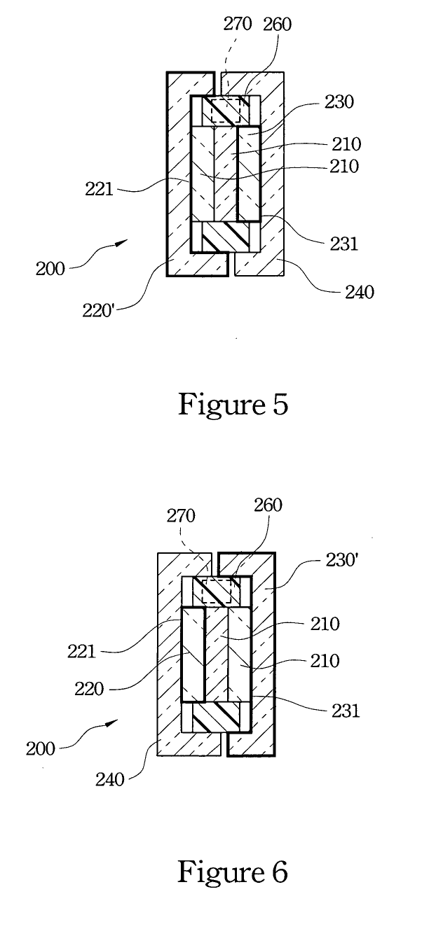

Refer to the FIG. 5. FIG. 5 illustrates a sectional view of a second embodiment of the auto darkening eye protection device of the present invention. The body 200 includes a first filter 220′, two liquid crystal filters 210, a second filter 230 with coat 231 or dyeing, a first housing 240, a covering layer 260 and a control circuit 270.

The fabrication and structure of the liquid crystal filters 210, the second filter 230, the first housing 240, the covering layer 260 and the control circuit 270 in the second embodiment are the same as the fabrication and structure in the first embodiment of FIG. 4. Thus, there is no more detailed description in the following.

The first filter 220′ in the second embodiment is a light-transparent plate made of plastic material with coat 221 or dyeing. In this embodiment, the first filter 220′ is capable of filtering the light and has the same function as the housing.

In this way, the liquid crystal filters 210 can also be protected by the first filter 220′ and the second filter 230. Furthermore, the effects of the second embodiment, filtering ultraviolet, filtering infrared ray, enduring impact and extending the using period, are the same as the effects of the first embodiment. Thus, there is no more detailed description in the following.

Refer to FIG. 6. FIG. 6 illustrates a sectional view of a third embodiment of the auto darkening eye protection device of the present invention. The body 200 includes the first housing 240, the first filter 220, two liquid crystal filters 210, a second filter 230′, a covering layer 260 and a control circuit 270.

The fabrication and structure of the first housing 240, the first filter 220, the liquid crystal filters 210, the covering layer 260 and the control circuit 270 in the third embodiment are the same as the fabrication and structure in the first embodiment of FIG. 4. Thus, there is no more detailed description in the following.

The second filter 230′ in the third embodiment is a light-transparent plate made of plastic material with coat 231 or dyeing. In this embodiment, the second filter 230′ is capable of filtering the light and has the same function as the housing.

In this way, the liquid crystal filters 210 can be also protected by the first filter 220 and the second filter 230′. Furthermore, the effects of the third embodiment, filtering ultraviolet, filtering infrared ray, enduring impact and boosting the using period, are the same as the effects of the first embodiment and the second embodiment. Thus, there is no more detailed description in the following.

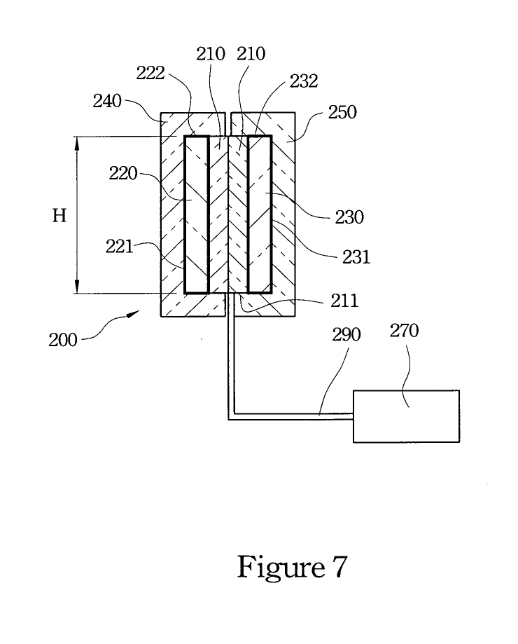

Refer to FIG. 7. FIG. 7 illustrates a sectional view of a fourth embodiment of the auto darkening eye protection device of the present invention. The body 200 includes two liquid crystal filters 210, a first filter 220, a second filter 230, a first housing 240, a second housing 250 and a control circuit 270.

The first filter 220 and the second filter 230 are both made of plastic material with light-transmitting such that the ultraviolet and the infrared ray can be shaded. A film 221 and a film 231 with anti-ultraviolet and anti-infrared ray functions are coated on the first filter 220 and the second filter 230. A dye method can also be used to manufacture the filters with anti-ultraviolet and anti-infrared ray functions during the plastic injection molding of the first filter 220 and the second filter 230.

The liquid crystal filters 210 are hermetically set between the first filter 220 and the second filter 230.

The first housing 240 is made of plastic material with light-transmitting and is hermetically covered in the external of the first filter 220.

The second housing 250 is made of plastic material with light-transmitting and is hermetically covered in the exterior of the second filter 230.

The control circuit 270 is connected with the liquid crystal filters 210 by an electrical wire 290 to control the liquid crystal filters 210. The electrical wire 290 is extended from the liquid crystal filters 210 to the exterior of the body 200.

In the fourth embodiment, the height H (the viewing area of the body 200) of the liquid crystal filter 210 is equal to the height H1 (the lens window of the body 200) of the first filter 220 and the second filter 230. Thus, the covering layer 260 in FIG. 4 is removed because the control circuit 270 is set in the exterior of the body 200 by an electrical wire 290.

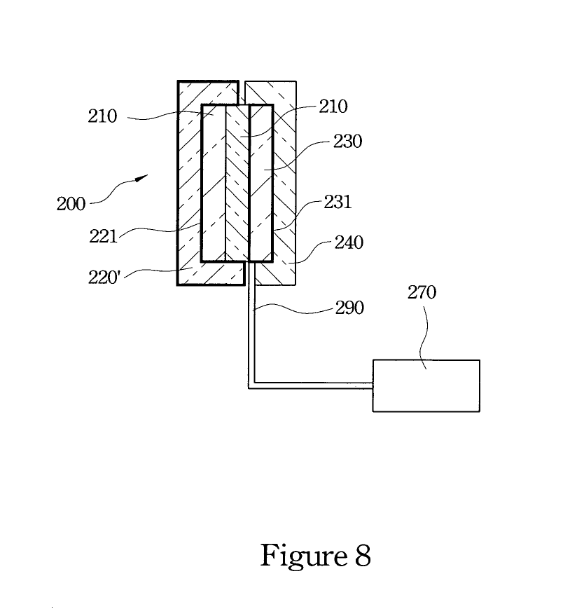

Refer to FIG. 8. FIG. 8 illustrates a sectional view of a fifth embodiment of the auto darkening eye protection device of the present invention. The embodiment concept of the body 200 of the fifth embodiment is the same as the second embodiment in FIG. 5. The body 200 of the fifth embodiment includes the first filter 220′ with dyeing method or the film 221, two liquid crystal filters 210, a second filter 230 with dyeing method or the film 231, a first housing 240 and a control circuit 270. The difference between the second embodiment and the fifth embodiment is that the covering layer 260 is removed because the control circuit 270 is set in the exterior of the body 200 by the electrical wire 290.

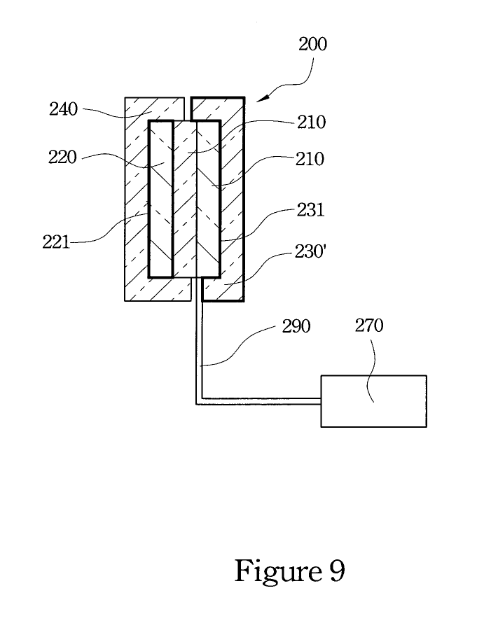

Refer to FIG. 9. FIG. 9 illustrates a sectional view of a sixth embodiment of the auto darkening eye protection device of the present invention. The embodiment concept of the body 200 of the sixth embodiment is the same as the third embodiment in FIG. 6. The body 200 of the sixth embodiment includes the first closing 240, the first filter 220 with a coat 221, two liquid crystal filters 210, the second filter 230′ with dyeing method or the coat 231 and a control circuit 270. The difference between the third embodiment and the sixth embodiment is that the covering layer 260 is removed because the control circuit 270 is set in the exterior of the body 200 by the electrical wire 290.

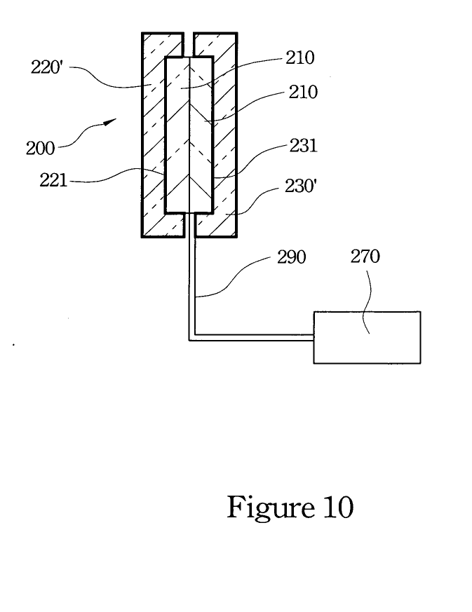

Refer to FIG. 10. FIG. 10 illustrates a sectional view of a seventh embodiment of the auto darkening eye protection device of the present invention. The body 200 of the seventh embodiment includes the first filter 220′ with dyeing method or the coat 221, two liquid crystal filters 210, the second filter 230′ with dyeing method or the coat 231 and the control circuit 270 set in the exterior of the body 200 by the electrical wire 290. The first filter 220′ and the second filter 230′ substitute the first housing 240 and the second housing 250 in FIG. 4 and FIG. 7. Therefore, the first housing 240 and the second housing 250 in FIG. 4, FIG. 5, FIG. 6, FIG. 7, FIG. 8 and FIG. 9 are removed to reduce the cost and minimize the weight.

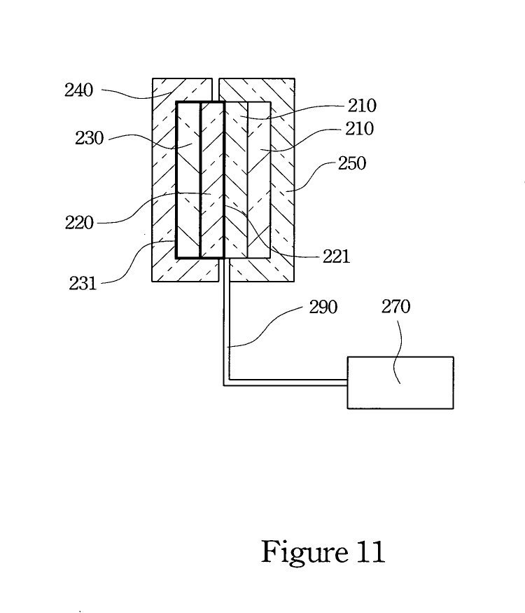

Refer to FIG. 11. FIG. 11 illustrates a sectional view of an eighth embodiment of the auto darkening eye protection device of the present invention. The body 200 of the eighth embodiment includes the first housing 240, the first filter 220 with dyeing method or the coat 221, the second filter 230 with dyeing method or a coat 231, two liquid crystal filters 210, the second housing 250 and a control circuit 270. The control circuit is set in the exterior of the body 200 by the electrical wire 290. Besides, these above filters and housings are adjacent to one by another. In this embodiment, the two liquid crystal filters 210 are adjacent to each other and connected with the first filter 220 and the second filter 230 wherein the first filter 220 is adjacent to the liquid crystal filters 210. The first housing 240 and the second housing 250 hermetically cover the first filter 220, the second filter 230 and the liquid crystal filters 210. Therefore, the same effects as other embodiments are provided.

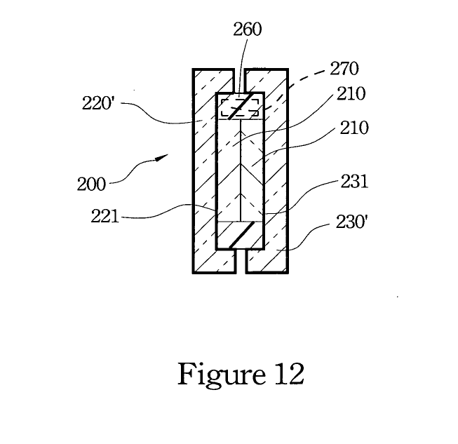

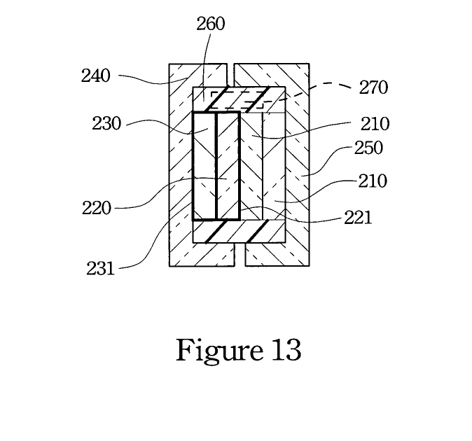

Refer to FIG. 12 and FIG. 13. FIG. 12 and FIG. 13 respectively illustrate a sectional view of a ninth and tenth embodiment of the auto darkening eye protection device of the present invention. The embodiment concept of the body 200 of the ninth and tenth embodiment is respectively the same as the seventh and eighth embodiment in FIG. 10 and FIG. 11. The body 200 of the ninth and tenth embodiment further include the covering layer 260. The difference between the seventh and eighth embodiment and the ninth and tenth embodiment is that the control circuit 270 in the ninth and tenth embodiment is embedded in the interior of the covering layer 260.

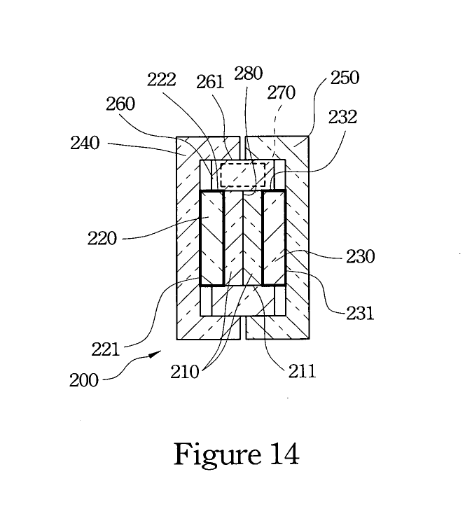

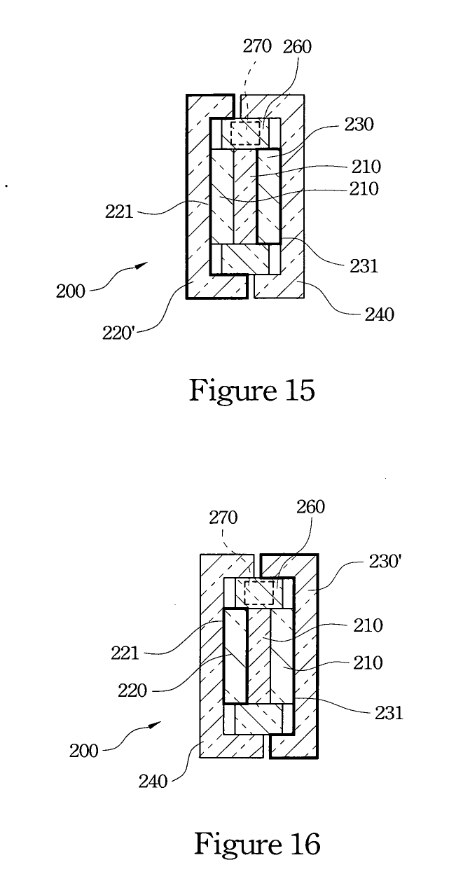

Refer to FIG. 14, FIG. 15 and FIG. 16. FIG. 14, FIG. 15 and FIG. 16 respectively illustrate a sectional view of an eleventh, twelfth and thirteenth embodiment of the auto darkening eye protection device of the present invention. The embodiment concept of the body 200 of the eleventh, twelfth and thirteenth embodiment is respectively the same as the first, second and third embodiment in FIG. 4, FIG. 5 and FIG. 6. The difference between the first, second and third embodiment and the eleventh, twelfth and thirteenth embodiment is that the covering layer 260 of the eleventh, twelfth and thirteenth embodiment is made of light-transmitting material capable of shading the ultraviolet (UV) and infrared (IR) rays. The transmitted light from the first housing 240, the covering layer 260 and the second housing 250 has an average first light-transmitting ratio. Besides, the transmitted light from the first housing 240, the first filter 220, the liquid crystal filters 210, the second filter 230 and the second housing 250 has an average second light-transmitting ratio. The first light-transmitting ratio and the second light-transmitting ratio are under a light-transmitting ratio scope with same shade number level. Accordingly, the viewing area of the body 200 of the eleventh, twelfth and thirteenth embodiment is enlarged during the dark state.

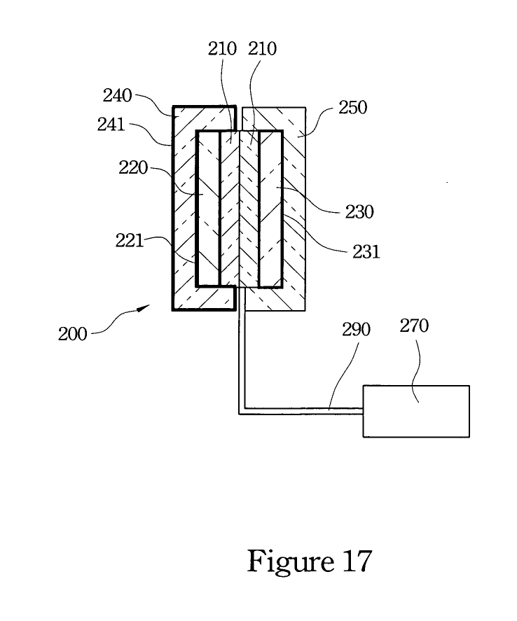

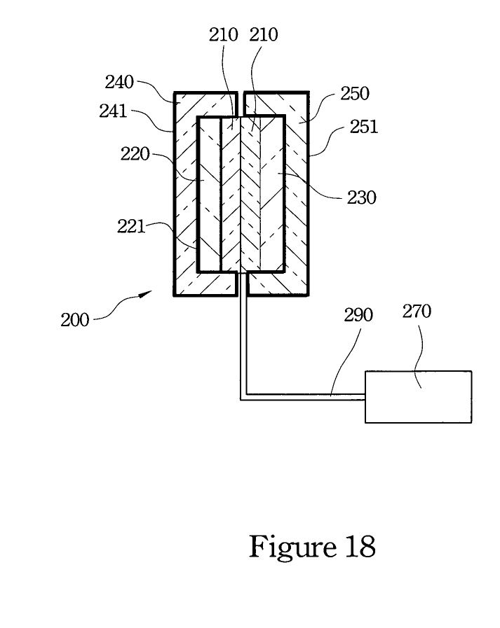

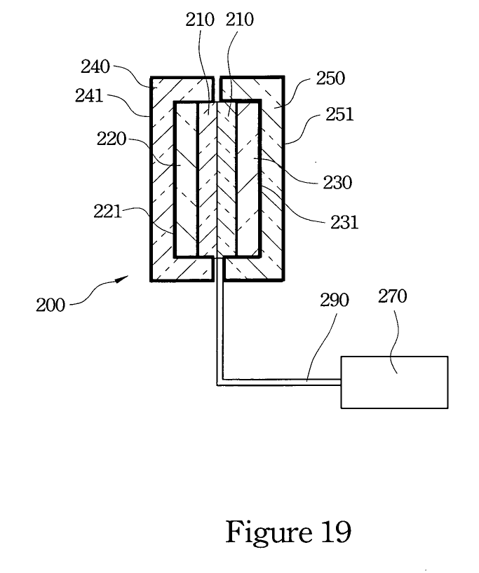

Refer to FIG. 7 and FIG. 17. FIG. 17 illustrates a sectional view of a fourteenth embodiment of the auto darkening eye protection device of the present invention. The difference between the fourth embodiment of FIG. 7 and the fourteenth embodiment of FIG. 17 is that the first housing 240 of fourteenth embodiment in FIG. 17 has a film 241. Refer to FIG. 17 and FIG. 18. FIG. 18 illustrates a sectional view of a fifteenth embodiment. In the fifteenth embodiment of FIG. 18, the second housing 250 has a film 251 in place of the film 231 of the second filter 230 in FIG. 17. For the requirement of the IR filtering, the requirement of the single filtering layer design (<0.7%) is higher than the double filtering layers design (<8.5%). Therefore, the double filtering layers design is easier for manufacturing to comply with the requirement. Refer to FIG. 17 and FIG. 19. FIG. 19 illustrates a sectional view of a sixteenth embodiment. All the filtering layers, the first housing 240, the first filter 220, the second filter 230 and the second housing 250, respectively have films, the film 241, the film 221, the film 231 and the film 251, to shade the ultraviolet (UV) and infrared (IR) rays.

Although the present invention has been described in considerable detail with reference to certain embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auto darkening eye protection device, comprising:
a first filter and a second filter made of light-transmitting plastic to shade ultraviolet (UV) and infrared (IR) rays;
at least one liquid crystal filter adjacently connected with the first filter; and
a control circuit electrically connected with the liquid crystal filter to control the liquid crystal filter.

2. The auto darkening eye protection device of claim 1, further comprising a first housing covering the first filter and made of light-transmitting plastic.

3. The auto darkening eye protection device of claim 1, wherein the liquid crystal filter is set between the first filter and the second filter.

4. The auto darkening eye protection device of claim 2, further comprising a second housing covering the second filter and made of light transmitting plastic.

5. The auto darkening eye protection device of claim 4, wherein the second housing corresponds oppositely to the first housing.

6. The auto darkening eye protection device of claim 5, wherein the first housing and the second housing hermetically cover the first filter, the second filter and the liquid crystal filter.

7. The auto darkening eye protection device of claim 2, wherein the second filter corresponds oppositely to the first housing and hermetically covers the liquid crystal filter.

8. The auto darkening eye protection device of claim 6, further comprising a covering layer set between the liquid crystal filter and the first housing and the second housing wherein the control circuit is embedded in the covering layer.

9. The auto darkening eye protection device of claim 8, wherein the covering layer is made of light-opacity material.

10. The auto darkening eye protection device of claim 8, wherein the covering layer is made of light-transmitting material capable of shading ultraviolet (UV) and infrared (IR) rays.

11. The auto darkening eye protection device of claim 8, wherein the liquid crystal filter has a height less than a height of the covering layer.

12. The auto darkening eye protection device of claim 6, wherein the liquid crystal filter has a height equal to a height of the first filter and the second filter.

13. The auto darkening eye protection device of claim 8, wherein the covering layer is located in a periphery of the liquid crystal filter and between the first filter and the second filter.

14. The auto darkening eye protection device of claim 1, wherein the first filter and the second filter are respectively coated with a light-transmitting coat.

15. The auto darkening eye protection device of claim 1, wherein the first filter and the second filter are respectively added with a light-transmitting dye.

16. The auto darkening eye protection device of claim 5, wherein at least one of the first housing and the second housing is coated with a light-transmitting coat.

17. The auto darkening eye protection device of claim 5, wherein at least one of the first housing and the second housing has a light-transmitting dye.

18. The auto darkening eye protection device of claim 6, further comprising an adherent layer attaching the first housing, the first filter, the liquid crystal filter, the second filter and the second housing wherein these above filters and layers are adjacently connected with each other.
